(19) United States
(12) Patent Application Publication
(10) Pub. No.: US 2014/0124147 A1
(43) Pub. Date: May 8, 2014

(54) INSULATING AND ORNAMENTAL SYSTEM FOR A GARAGE DOOR ASSEMBLY

(71) Applicant: Iso-Porte Inc., St-Jean-sur-Richelieu (CA)

(72) Inventor: Eric LEFEBVRE, St-Jean-sur-Richelieu (CA)

(73) Assignee: Iso-Porte Inc., St-Jean-sur-Richelieu (CA)

(21) Appl. No.: 14/075,851

(22) Filed: Nov. 8, 2013

Related U.S. Application Data
(60) Provisional application No. 61/723,814, filed on Nov. 8, 2012.

(51) Int. Cl. E06B 5/00

(52) U.S. Cl. CPC E06B 5/00
USPC 160/40

(57) ABSTRACT

In a sectional overhead garage door assembly, the problem of inefficient and/or insufficient insulation of a garage door assembly that comprises a door for closing an entrance is solved by covering joints and openings of the door assembly with isolating members so that the joints and openings of the door assembly other than the entrance remain close when the door is opened. For example, an embodiment of an insulation system includes a lateral insulating assembly to be secured to a door frame or wall adjacent the garage door; and a resilient insulating assembly is secured to at least one of the garage door along the lateral edge thereof and the lateral insulating assembly for defining an enclosure with the garage door and the lateral insulating assembly. In some embodiment, each door panel is provided with a door panel insulating assembly.

### CROSS-REFERENCE TO RELATED APPLICATIONS

This application claims the benefit of U.S. Application 61/723,814 filed Nov. 8, 2012, the contents of which are incorporated herein by reference.

### FIELD

The present disclosure generally relates to garage doors. More specifically, the present disclosure is concerned with an insulating and ornamental system for a garage door assembly such as a sectional overhead garage door assembly.

### BACKGROUND

With the ever increasing energy costs, the need for good thermal insulation in windows and doors become increasingly important, and garage doors are no exceptions.

Among the many types of garage doors, the sectional overhead doors are among the most popular for style, safety, security and ease of use. They include a series of panels abutted so that two adjacent panels are hinged or pivotally mounted to one another. Such a system can be moved between closed and opened configuration by sliding the panel assembly along lateral tracks between vertical and horizontal positions by way of a cable and pulley system that is motorized by a small electric motor or which is operated manually.

There are known insulating systems for folding doors or sectional overhead garage doors. Some of these systems aim at totally or partially replacing conventional garage doors and as such cannot be retrofitted to existing doors. The following documents show examples of such door assemblies:
U.S. Pat. No. 4,452,293, issued on Jun. 5, 1984 to Gorse and being titled “Folding Door”;
U.S. Pat. No. 5,435,108, issued on Jul. 25, 1995 to Overholt et al. and being titled “Insulated garage Door Panel”; and
International Patent Application Publication No. WO 2004/085784 A1, published on Oct. 7, 2004, naming Stevens et al. as the inventors and being titled “A Door Panel”.

Few solutions seem to exist to add insulation to conventional sectional overhead garage doors. The following is known in the art: adding permanent or removable localized insulation materials; and cover the whole of the door by a removable cover. These solutions have the drawback of being either partial and/or to prevent normal use of the door while they are installed.

### SUMMARY

The problem of inefficient insulation of a garage door assembly that comprises a door for closing an entrance is solved by covering joints and openings of the door assembly with isolating members so that the joints and openings of the door assembly other than the entrance remain closed when the door is opened.

More specifically, in accordance with an illustrative embodiment, there is provided an insulating system for a sectional overhead garage door assembly that closes an entrance, the system comprising:

a plurality of door panel insulating assemblies, each to be secured to a respective door panel of the garage door assembly; and

two lateral insulating assemblies, each to be secured to the door assembly adjacent the entrance and defining an enclosure with the plurality of door panel insulating assemblies and the garage door assembly.

In accordance to another embodiment, there is provided insulating assembly comprising:

two insulating side members to be secured to a door frame adjacent a garage door on respective lateral sides thereof; and

two sealing assemblies, each to be secured to at least one of i) the garage door along a respective lateral edge thereof and ii) a respective insulating side member for defining an enclosure with the garage door and the insulating side member.

According to still another embodiment, there is provided an insulating system for a sectional overhead garage door assembly that closes an entrance, the system comprising:

a plurality of door panel insulating assemblies, each to be secured to a respective door panel of the garage door assembly; and

two lateral insulating assemblies, each secured to the door assembly adjacent the entrance so as to define an insulating enclosure with the plurality of door panel insulating assemblies and the garage door assembly; each of the two lateral insulating assembly including an insulating side member to be secured to the door assembly adjacent the garage door on respective lateral sides thereof, and a sealing assembly, to be secured to at least one of a respective insulating side member, at least one of the plurality of door panel insulating assemblies, and at least one of the door panels for defining an insulating enclosure with the plurality of door panel insulating assemblies and the garage door assembly.

Other objects, advantages and features of the present disclosure will become more apparent upon reading the following non restrictive description of illustrated embodiments thereof, given by way of example only with reference to the accompanying drawings.

### BRIEF DESCRIPTION OF THE DRAWINGS

In the appended drawings:

FIG. 1 is a top perspective of an insulating system for a sectional overhead garage door assembly, the system being shown mounted to a door assembly;

FIG. 2 is a side sectional view of the system from FIG. 1;

FIG. 3 is a top perspective of the system from FIG. 1, wherein only the parts thereof that are made of extruded polystyrene foam are shown;

FIG. 4 is a perspective close up view of the system from FIG. 1, showing the added insulation at the bottom of the lowermost insulating panel;

FIG. 5 is an isolated exploded view of the parts shown in FIG. 3;

FIG. 6 is a close up perspective of the system from FIG. 1, showing the assembly thereof that encloses a lateral track of the door assembly;

FIG. 7 is an broken bottom perspective of the system from FIG. 1, showing the door partly raised;

FIG. 8 is a broken partly exploded perspective of the system from FIG. 1, showing the door closed with one of the lateral insulating assemblies removed; and

FIG. 9 is a close up perspective of a lateral insulating assembly according to a second illustrative embodiment.

### DETAILED DESCRIPTION

In the following description, similar features in the drawings have been given similar reference numerals, and in order not to weigh down the figures, some elements are not referred to in some figures if they were already identified in a previous figure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

The expression “joints” is to be construed, in the description and in the claims, as to include spots, lines or areas where elements, bodies, assemblies and/or parts are joined.

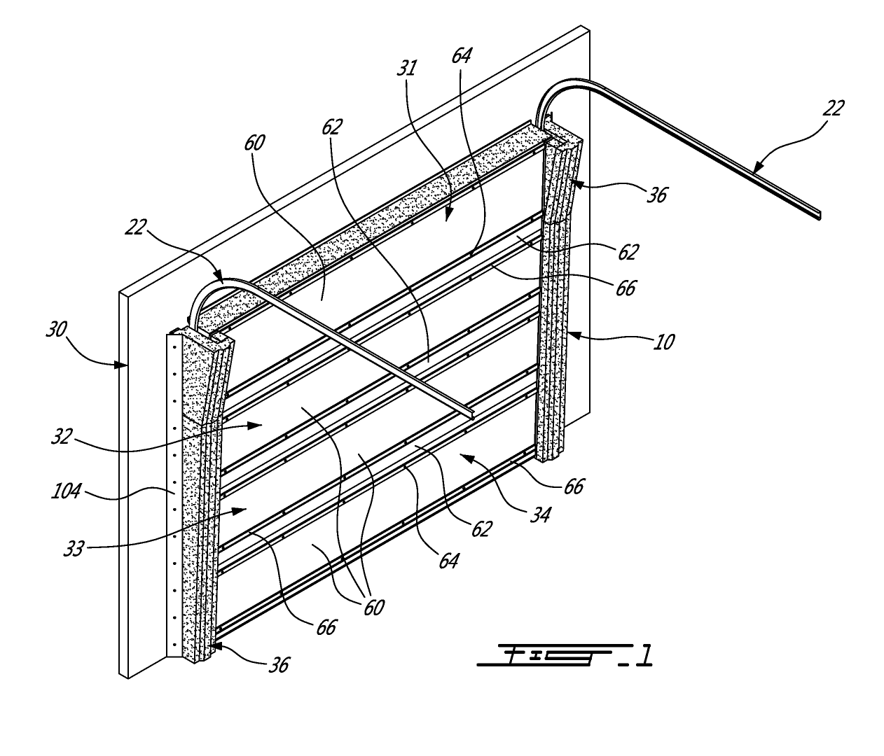

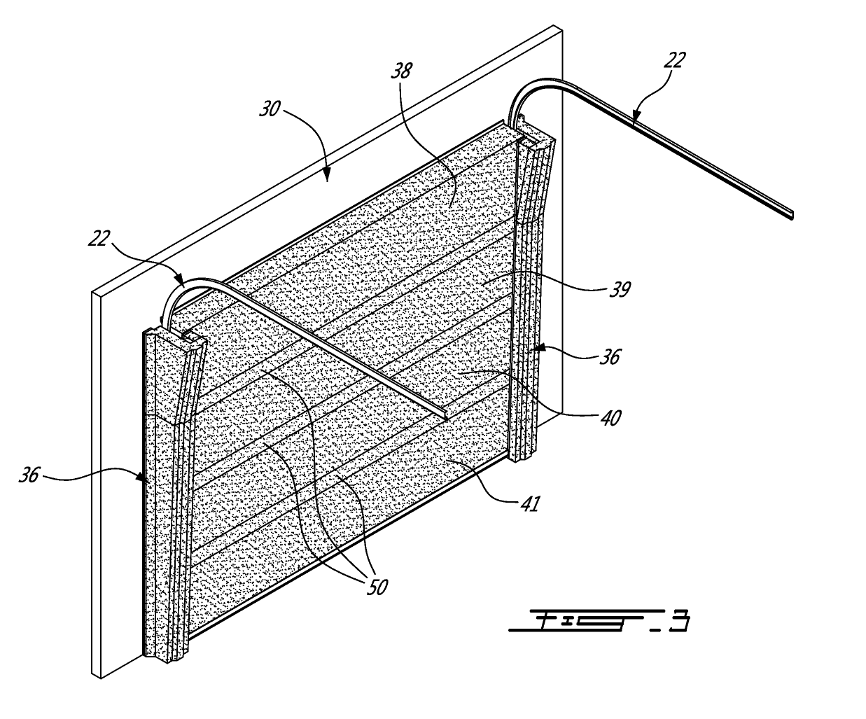

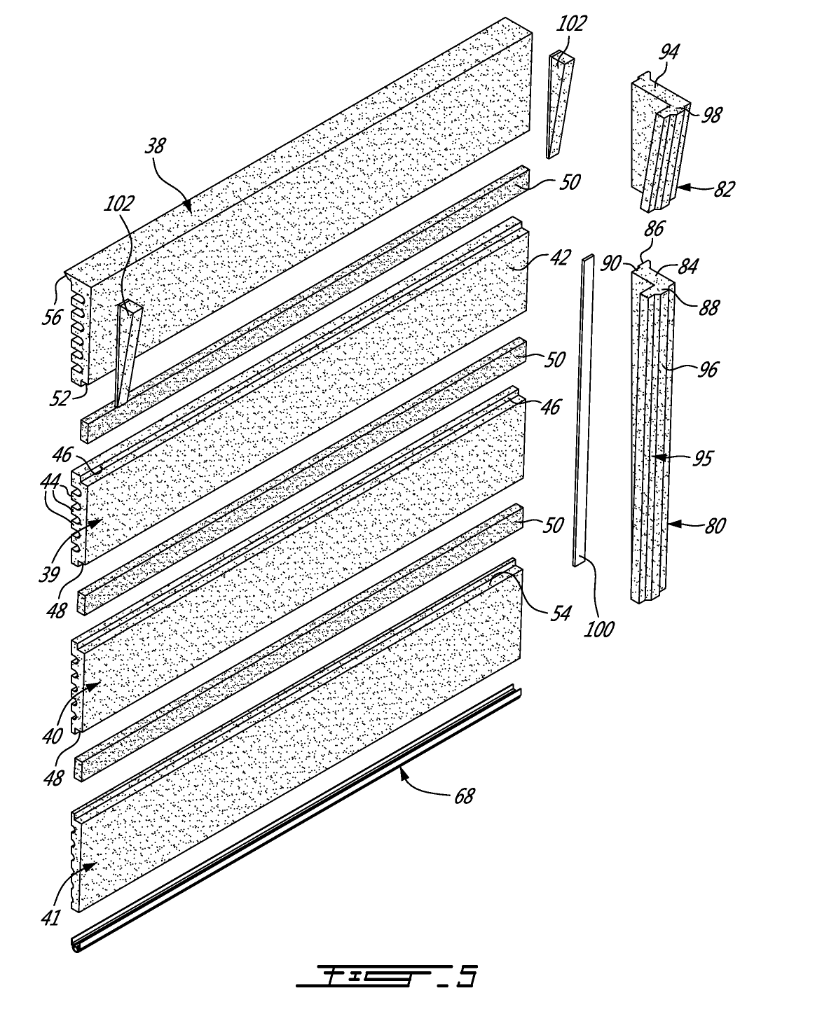

An insulating system 10 for a garage door assembly 12 will now be described with reference first to FIGS. 1 to 5.

According to the first embodiment, the garage door assembly 12 is a sectional overhead garage door assembly comprising a series of identical abutting panels 14, 16, 18 and 20 that are assembled in such a way that two adjacent panels 14-16, 16-18 and 18-20 are so interconnected to allow pivotal movement therebetween. More specifically, each two adjacent panels 14-20 are assembled using conventional hinges (not shown). Each of the panels 14-20 is slidably mounted to two lateral parallel tracks 22 therebetween for reciprocal movement in unison therealong between an upright lowered position, wherein the entrance 25 is closed, and a raised position, wherein the entrance 25 is clear.

It is to be noted that panels 14-20 of the door assembly 12 are identical and are only referred to herein by different numeral references to distinguish their relative position.

The tracks 22 conventionally includes a lower vertical portion 24, a generally horizontal portion 26 and an arcuate transitional portion 28 therebetween.

The garage door assembly 12 includes a frame 30 or wall portions that define the rectangular door entrance therebetween.

For concision and simplification purposes, the expression “frame” with reference to the door assembly is to be construed as including the actual frame of the door assembly and/or the wall or structure adjacent thereto.

The insulating system 10 comprises a plurality of door panel insulating assemblies 31-34, each mounted to a respective one of the door panels 14-20, and two lateral insulating assemblies 36, each mounted to the frame 30 on a respective lateral side of the entrance 25.

The door panel insulating assemblies 31-34 will now be described in more detail.

Each of the panels 31-34 includes a respective one-piece panel 38-41 made of extruded polystyrene foam mounted thereto. The width and length of each panel 38-41 is such that it generally conforms to the panel of the panels 31-34 to which it is secured. Each of the panels 38-41 has a planar front portion 42 of a similar thickness that is distanced from the respective door panels 14-20 by a plurality of legs 44 of increasing length from the bottom side to the top side of the panels 38-41. More specifically, the lengths of the legs 44 are such that the planar front portions 42 of the panels 38-41 together define a plane 47 which is slanted relative to the door panels 14-20. The reason for this configuration of the panels 38-41 will be given hereinbelow.

Each of the top and bottom edges of the panels 39 and 40 defines generally parallel longitudinal shoulder portions 46 and 48. As will be described hereinbelow in more detail, the bottom and top shoulder portions 48 and 46 of two adjacent panels, such as 39 and 40 are configured to complement each-other when the insulating panels 39 and 40 are secured to their respective door panels 16 and 18 to define a groove that receives a deformable sealing element 50. For that same purpose, the bottom edge of the of the top insulating panel 33 defines shoulder 52 and the top edge of the bottom insulating panel 41 defines shoulder 54.

The top edge of the top insulating panel 38 includes a sealing flange 56 that is configured to extend over the top door panel 14 when the insulating panel 38 is secured thereon.

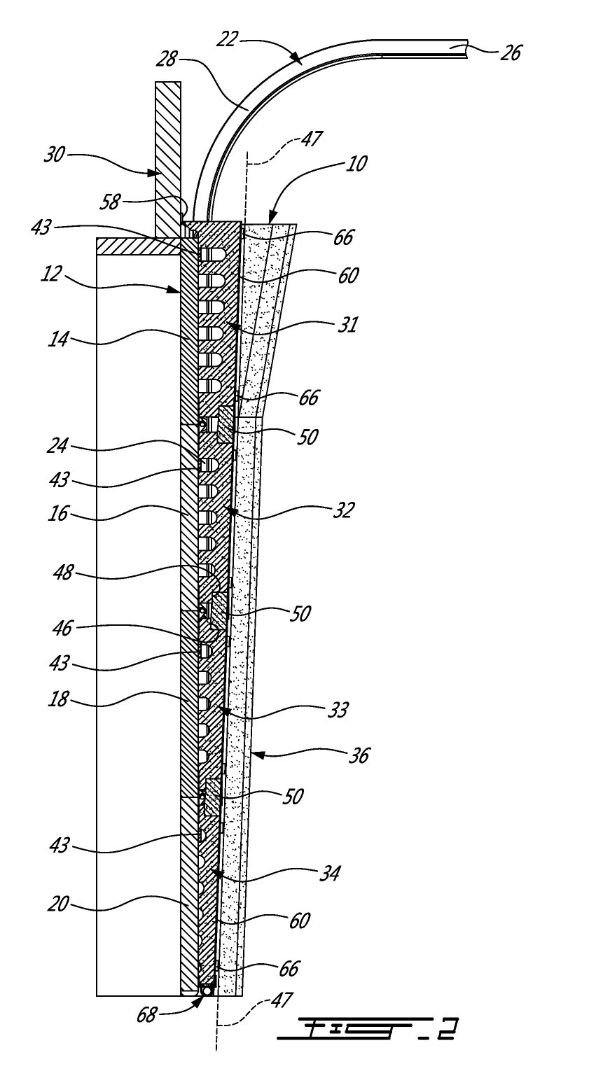

As can be better seen in FIG. 2, the flange 56 abuts and complements a sealing track 58 secured to the frame 30 above the entrance 25.

Each of the door panel insulating assemblies 31-34 are substantially covered by a protective sheet 60 that is made of a polyvinyl chloride (PVC) foam or of another polymeric material. A flexible strip 62 made of a same or different material than the protective sheet 60 is provided between each two adjacent insulating panels to cover and maintain in place a corresponding deformable sealing element 50.

The sheets 60, strips 62 and panels 38-41 are secured to respective door panels 31-34 using fasteners 64. Longitudinal furring strips 66 are provided between the fasteners 64 and the sheets 60 or strips 62. According to another embodiment, the furring strips 66 are omitted.

According to another embodiment (not shown), glue, self-adhesive elements, and/or other similar fastening means (not shown) are further or alternatively used in securing the insulating panels 38-41, sheets 60 and/or strips 62.

A rigid strip 43 is secured to each door panel 12-18 so as to be positioned within one of the grooves defined by the legs 44 for abutting the upper side of the leg 44 positioned above the strip 43. The strip 43 is provided to prevent upward and/or downward movements of the panel assemblies 31-34 relative to the door panels 12-18. The strips 43 are secured to the door panels 31-34 using fasteners.

According to another embodiment (not shown), a single strip 43 is secured to one of the door panels 12-18. According to still another embodiment (not shown), the strips 43 are omitted.

The combination of a deformable sealing element 50 with a corresponding overlaying strip 62 defines a deformable panel joint. According to other embodiment, either one of the deformable sealing element 50 and strip 62 is omitted and the other element 50 or 62 alone defines the deformable panel joint.

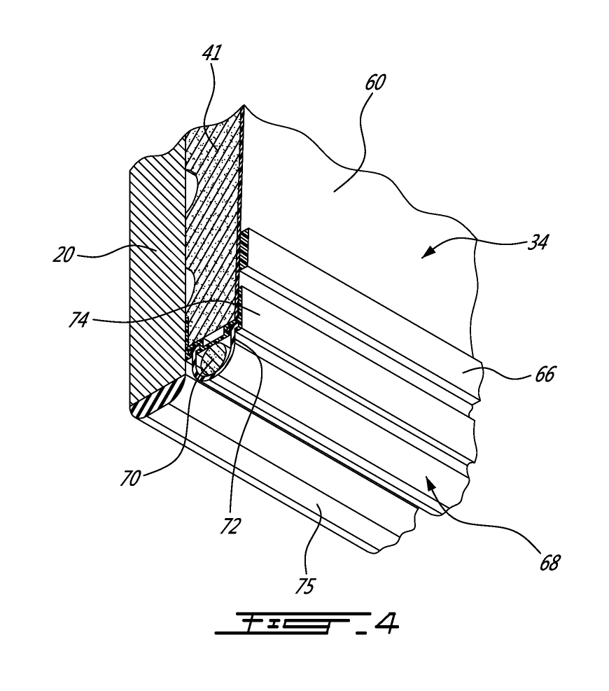

Turning now briefly to FIG. 4, a deformable bottom seal element 68 is secured to the free edge of the bottom door panel insulating assembly 34. The element 68 includes a deformable tubular member 70 in a protective sleeve 72 made of rubber or of another resilient and water-resistant material, secured together to the bottom edge of the assembly 34 via a U-shaped bracket 74.

The seal 68 is not limited to the illustrated embodiment and any deformable and water-resistant body or assembly can be used as a seal under the bottom edge of the insulating assembly 34. This seal can be omitted.

The member 68 is configured so as to have a thickness and resilience similar to the bottom seal 75 of the door panel 20.

Since such door seals are well known in the art, they will not be described herein in more detail for concision purposes.

It is to be noted that the door panel insulating assemblies 31-34 are not limited to the illustrated embodiment. For example, another insulating material than extruded polystyrene foam can be used for the insulating panels 38-41. The shape thereof is also not limited to the illustrated planar front portion 42 distanced from the respective door panels 14-20 by a plurality of legs 44. For example, the leg portion can be replaced by a regular thickness. The protective sheets 60 can be omitted, replaced by thick panels, or by a thin wrapping material. The material of the protective sheets 60 is also not limited to a polymeric material, and wood, for example, can also be used. The deformable sealing elements 50 can also be omitted.

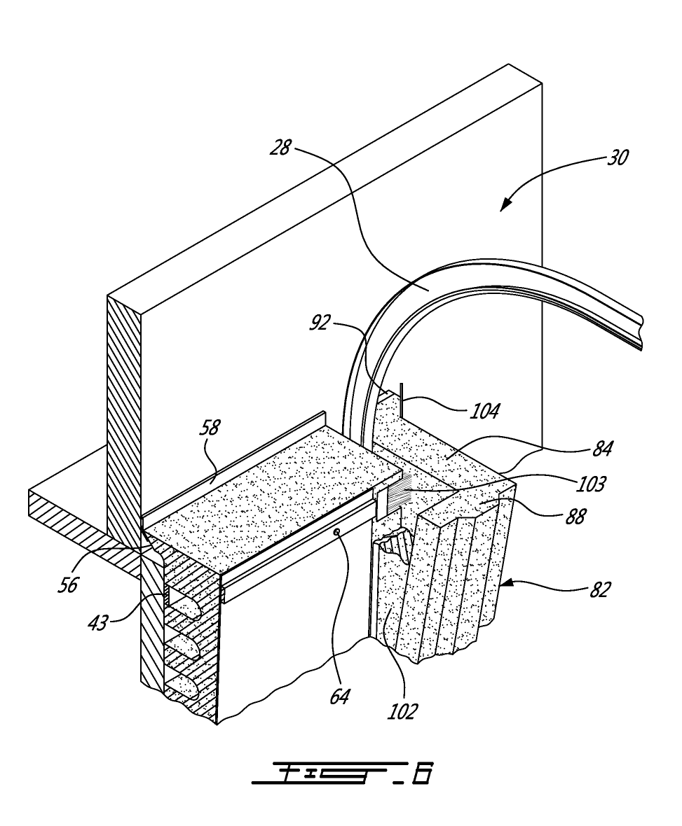

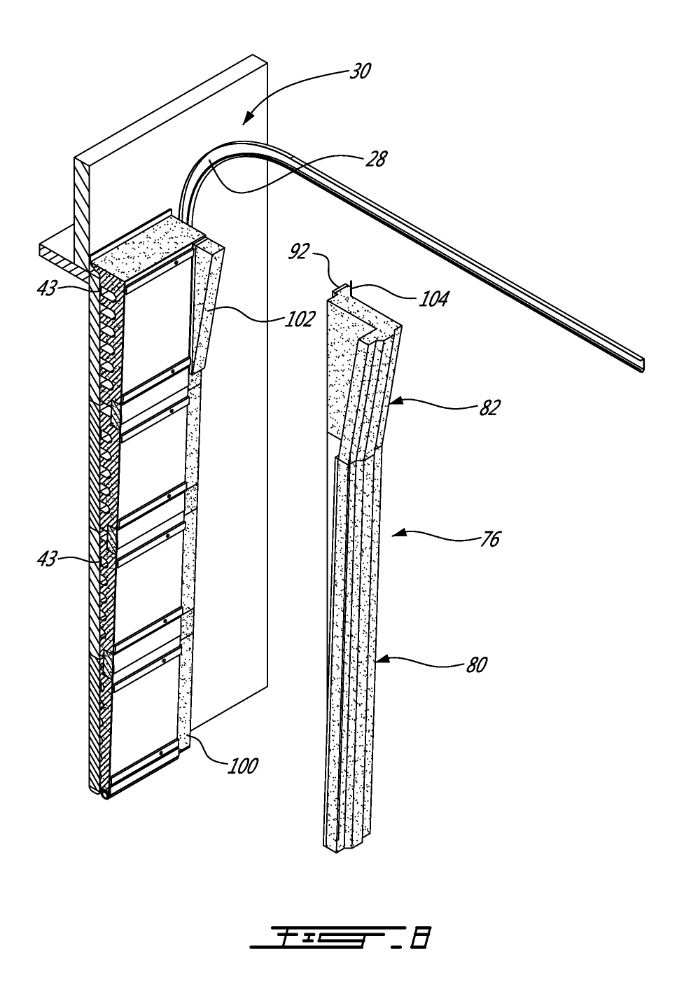

Since both lateral insulating assemblies 36 are mirror image of one another, only one of these two assemblies 36 will now be described for concision purposes, with reference more specifically to FIGS. 6-9.

The lateral insulating assembly 36 includes an insulating side member 76 secured to the door frame 30 adjacent the garage door panels 14-20, and a resilient sealing assembly 78 secured in part to the insulating side member 76 and in part to the insulating assembly 31 so as to define an enclosure with the garage door panel insulating assemblies 31-34 and the insulating side member 76.

The insulating side member 76 is a two part body, each part 80-82 being made of extruded polystyrene foam or of another thermal insulating material and having a generally L-Shaped section.

The lower part 80 includes a first wall 84 having a lateral side edge 86 that mounts the insulating side member 76 to the frame 30 and a second wall 88 extending from the first wall 84 perpendicularly therefrom. The lateral side edge 86 is defined by a protrusion of the wall 84 for securing the lower part 80 to a furring strip 92 using fastening means such as glue, adhesive strips, fasteners, etc. The strip 92 is secured to the frame 30 adjacent the entrance 25 using fasteners and/or glue (not shown).

The enlargement face of the edge 86 defines a shoulder portion 90 that extends along the length of the edge 86 to define a clearance for the mounting brackets (not shown) of the rail 22.

The outer face 95 of the second wall 88 includes decorative patterns in the form of an elongated protrusion 96 extending through its length.

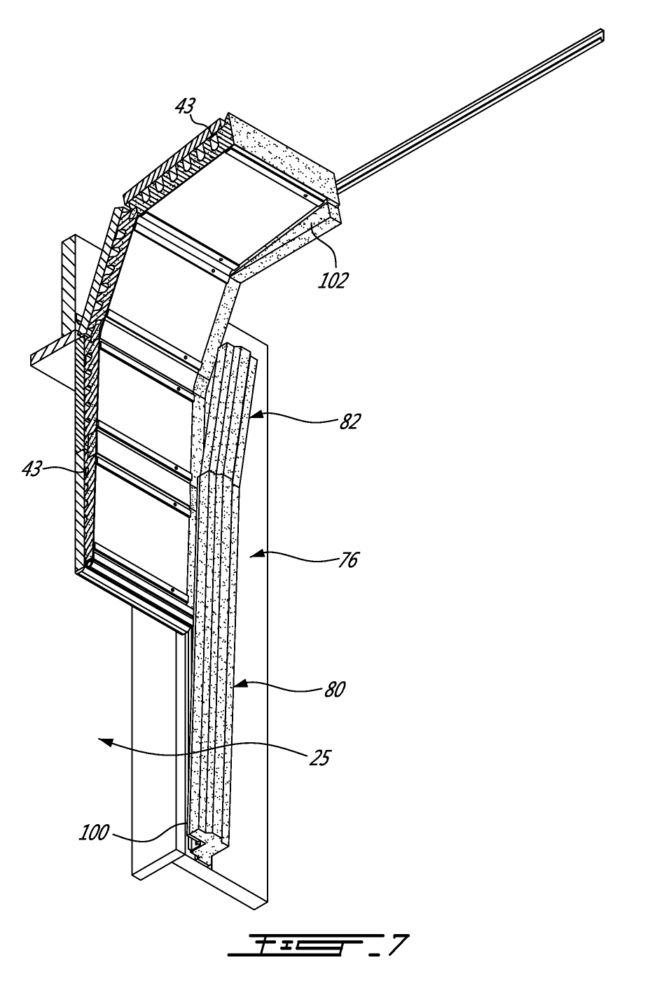

The upper part 82 of the member 76 is similar to the first part 80 and defines an extension therefrom. Aside from the shorter length of the second part 82, a difference between the two parts 80 and 82 is that the second wall 98 of the upper part 82 defines an angle with the second wall 88 of the first part 80 when both parts 80-82 are mounted to the frame 30 so as to be abutted. As can be better seen in FIG. 7, the wall 98 being angled relative to the wall 88 yields a clearance for the angled passage of the door insulating panels 14-20 caused by the sliding thereof along the arcuate portion 28 of the track 22 when the panels 14-20 are raised. The first wall 99 of the upper part 82 is therefore tapered to yield a suitable angle.

Providing the insulating side member 76 in two parts allows manufacturing a lower part 80 with a geometry suitable to insulate the lateral side joint of most garage doors and a upper part 82 mountable to the lower part 80 that is adapted for the configuration of a particular garage door assembly.

According to another embodiment the member 76 is a one piece body or assembled from more than two parts.

The configurations and sizes of the insulating side member 76, and more specifically the length of the width of the walls 84, 88, 94 and 98 is such that there is sufficient clearance for the track 22 between the lateral edge of the door panels 12-18 and the walls 84, 88, 94 and 98. The width of the second walls 88 and 94 are such that they partially overlap the door panels 12-20 and their respective insulating panel assemblies 31-34.

An improved insulation is obtained by closing the gap between the walls 88, 98 and the door panel insulating assemblies 31-34 with a deformable sealing strip 100 between the wall 88 and the opposite insulating panel assemblies 31-34 and a triangular-shaped sealing element 102 that complementary fill the void between the wall 98 and the insulating panel assembly 31.

According to the illustrated embodiment, the sealing strip 100 is secured to the wall 88 of the insulating side member 76 using an adhesive, auto-adhesive strips or the and the sealing element 102 is secured to the insulating panel 38. However, these two elements 100-102 can be secured to anyone of the insulating door panel assemblies 31-34 and the insulating side member 76.

A protective strip 104 is also secured to the enlarge portion of the side wall 99 of the upper part 82, on the outer side thereof.

Each lateral insulating assembly 36 includes a seal in the form of a brush 103 (only one shown) that is secured to the door panel 12 using a bracket (not shown). Each brush 103 closes the passage defined by a respective lateral insulating assembly 36 and the door panel insulating assemblies 31-34 therebetween. Using brushes 103 as seals within said openings allows passage for the cable (not shown) and track 22 of the garage door opening mechanism (not shown) while limiting or preventing airflow.

According to another embodiment, a plurality of brushes 103 are positioned on each lateral side of the door panels 12-18. According to still another embodiment, the seals 103 have another form than a brush.

In operation, the garage door can be conventionally opened and closed without any added restriction to its operation by the insulating system 10.

When the garage door is completely closed (see FIG. 1), all joints in the door assembly 12 are sealed and/or thermally insulated. When the door is partially or completely opened (see FIG. 7) joints and openings of the door assembly other than the entrance remain closed.

It is to be noted that additional functionalities of the garage door assembly 12, such as a lock, sealing and security sensors (not shown) are untampered by providing the door assembly 12 with the insulating system 10.

In the case of a lock mechanism provided with conventional locking bars or rods, a groove can be provided in one or more insulating panels 38-41 to accommodate such a mechanism (not shown).

While the garage door insulating system 10 has been illustrated as being mounted to an existing door in a retrofitted way, it is believed to be within the reach of a person skilled in the art to use the present teaching to provide a new garage door installation with similar additional insulation than provided by the illustrated insulating system 10.

Also, in some embodiment, a garage door assembly is only provided with the lateral insulating assemblies, for example when the door panels are believed to provided sufficient insulation.

It is considered to be within the reach of a person skilled in art to use the present teaching to adapt the insulating system 10 for a garage door assembly having another configuration than those shown herein.

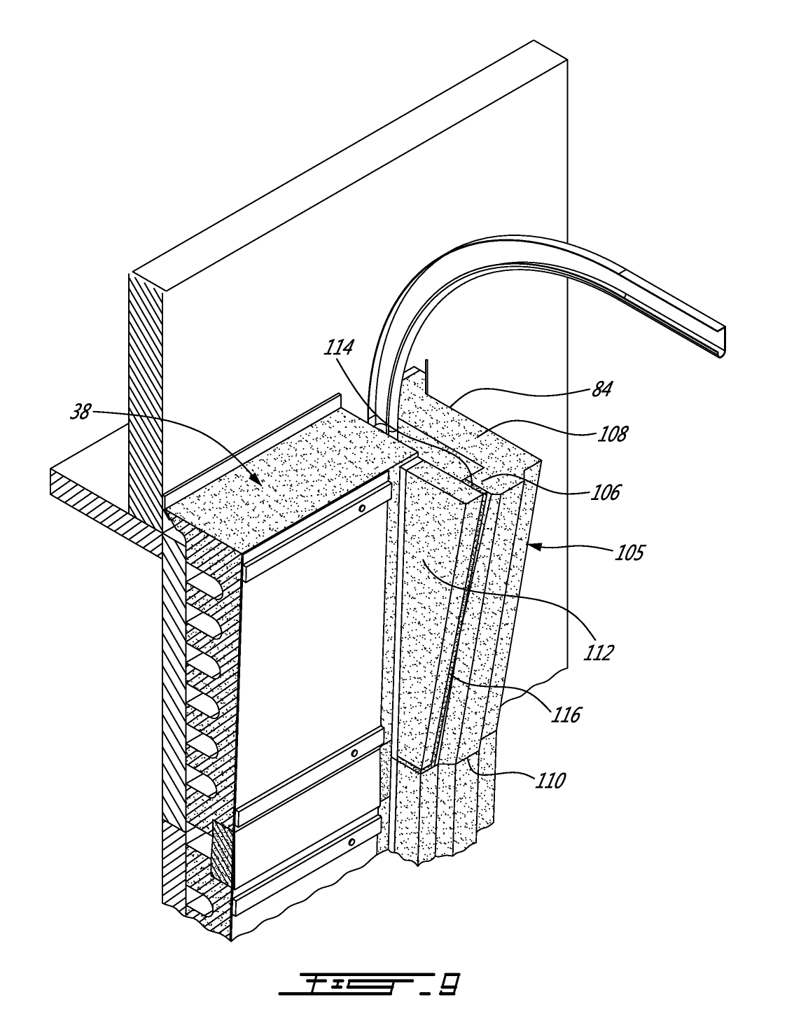

For example, FIG. 9 shows a second part 105 of a two part lateral side member according to a second illustrative embodiment, which is configured to abut the first part 80 thereon and to accommodate a cable (not shown) of the opening mechanism of a garage door assembly (not shown). Since this second part 105 is similar to the second part 82, only the differences therebetween will be described herein.

The second part 105 differs to the part 82 in that the wall 106 thereof, which corresponds to the wall 88 from the first illustrative embodiment, is truncated with an angle so that its upper side 108 is narrower than its bottom side 110. A triangular shape sealing element 112 is mounted to the insulating panel 38, and is configured and size to complement the second part 105. The second part 105 and sealing element 112 are configured to yield a gap 114 therebetween that allows passage for the cable or other part of the garage door assembly. A sealing element 116, made of neoprene or from another similar insulating and resilient material, is secured to the inner face of the wall 106 so as to close the gap 114.

It is to be noted that many other modifications could be made to the insulating system 10 described hereinabove and illustrated in the appended drawings. For example:
any or all of the panels and members of the insulating systems described above are not limited to being made of extruded polystyrene foam and can be made of other insulating material. They are also not limited to be in the form of molded bodies and can also be assembled from parts. For example, the insulating door panels 38-41 can be in the form of hollow panel-shaped boxes filled with an insulating material;
while some of the components of the insulating system 10 are illustrated as being covered by a protective layer, such a protective layer can be omitted;
the lateral insulating assemblies 36 are not limited to the illustrated embodiment. For example, the resulted enclosure configuration can obtained using other material than an insulating material such as extruded polystyrene foam. The shape of their insulating side member 76 is also not limited to the illustrated L-Shaped;
most elements of the insulating system 10 can be provided by ornamental features, including without limitations, colors, printings, shapes, etc.
the application of the above-described insulating system is not limited to the sectional overhead garage door assemblies and can be installed to other types of sliding door assemblies.

It is to be understood that the insulating system for a garage door assembly is not limited in its application to the details of construction and parts illustrated in the accompanying drawings and described hereinabove. The insulating system is capable of other embodiments and of being practiced in various ways. It is also to be understood that the phraseology or terminology used herein is for the purpose of description and not limitation. Hence, although the insulating system has been described hereinabove by way of illustrative embodiments thereof, it can be modified, without departing from the spirit, scope and nature of the subject invention.

What is claimed is:

1. An insulating system for a sectional overhead garage door assembly that closes an entrance, the system comprising:
a plurality of door panel insulating assemblies, each to be secured to a respective door panel of the garage door assembly; and
two lateral insulating assemblies, each to be secured to the door assembly adjacent the entrance and defining an enclosure with the plurality of door panel insulating assemblies and the garage door assembly.

2. The insulating system of claim 1, wherein each of the door panel insulating assemblies includes an insulating panel.

3. The insulating system of claim 2, wherein the insulating panel includes extruded polystyrene foam.

4. The insulating system of claim 2, wherein the insulating panel includes a front planar portion and a plurality of legs extending from the front planar portion for contacting the respective door panel.

5. The insulating system of claim 4, wherein each of the plurality of legs has a different length than the other legs, which results in the front planar portions defining together a slanted plane with regards to the door panels.

6. The insulating system of claim 4, wherein at least one of the door panel insulating assemblies includes a strip secured to the respective door panel for abutting one of the legs so as to prevent a downward movement of the plurality of door panel insulating assemblies.

7. The insulating system of claim 2, wherein facing sides of two adjacent insulating panels together define a space that receives a deformable sealing element.

8. The insulating system of claim 7, wherein the space that receives the deformable sealing element is further covered by a flexible strip.

9. The insulating system of claim 8, wherein at least one of the insulating panels is covered with a protective sheet.

10. The insulating system of claim 1, further comprising a plurality of deformable panel joints, each mounted between two respective adjacent door panel insulating assemblies.

11. The insulating system of claim 2, wherein at least one of the insulating panels is covered with a protective sheet.

12. The insulating system of claim 1, wherein one of the plurality of door panel insulating assemblies which is secured to a highest one of the door panels includes a flange for overlapping an upper edge of the highest one of the door panels.

13. The insulating system of claim 1, wherein one of the plurality of door panel insulating assemblies which is secured to a lowest one of the door panels includes a deformable bottom seal element secured to a lowest side thereof.

14. The insulating system of claim 1, wherein each of the two lateral insulating assemblies includes an insulating side member to be secured to the door assembly adjacent the entrance and a sealing assembly to be secured to at least one of the plurality of door panel insulating assemblies, a respective one of the two lateral insulating assemblies and the garage door assembly therebetween.

15. The insulating system of claim 14, wherein the insulating side member includes extruded polystyrene foam.

16. The insulating system of claim 14, wherein the insulating side member partially overlaps the plurality of door panel insulating assemblies.

17. The insulating system of claim 14, wherein the insulating side member has an L-shaped section.

18. The insulating system of claim 14, wherein the insulating side member includes upper and lower parts; the upper part having an angled wall to accommodate a track of the garage door assembly.

19. The insulating system of claim 18, wherein the sealing assembly includes a sealing member configured and sized to define a close perimeter around the track with the plurality of door panel insulating assemblies and the insulating side member.

20. The insulating system of claim 19, wherein the sealing member is configured to define a gap with the insulating side member therebetween to allow passage for a cable of the garage door assembly; the gap including a flat sealing element therein that is secured to one of the sealing member and insulating side member.

21. The insulating system of claim 14, wherein the sealing assembly includes a seal inserted in a passage defined by a respective lateral insulating side and the door panel insulating assemblies.

22. The insulating system of claim 21, wherein the seal includes a brush.

23. An insulating assembly comprising:
two insulating side members to be secured to a door frame adjacent a garage door on respective lateral sides thereof; and
two sealing assemblies, each to be secured to at least one of i) the garage door along a respective lateral edge thereof and ii) a respective insulating side member for defining an enclosure with the garage door and the insulating side member.

24. A garage door assembly comprising a door that closes an entrance and insulating members that are so mounted to the door assembly that joints and openings of the door assembly other than the entrance remain closed when the door is opened.

25. An insulating system for a sectional overhead garage door assembly that closes an entrance, the system comprising:
a plurality of door panel insulating assemblies, each to be secured to a respective door panel of the garage door assembly; and
two lateral insulating assemblies, each secured to the door assembly adjacent the entrance so as to define an insulating enclosure with the plurality of door panel insulating assemblies and the garage door assembly; each of the two lateral insulating assembly including an insulating side member to be secured to the door assembly adjacent the garage door on respective lateral sides thereof, and a sealing assembly, to be secured to at least one of a respective insulating side member, at least one of the plurality of door panel insulating assemblies, and at least one of the door panels for defining an insulating enclosure with the plurality of door panel insulating assemblies and the garage door assembly.
